(19) United States
(12) Patent Application Publication
(10) Pub. No.: US 2021/0251245 A1
(43) Pub. Date: Aug. 19, 2021

(54) CRISP PROTEINACEOUS FOOD PRODUCT

(71) Applicant: Michael Foods, Inc., Minnetonka, MN (US)

(72) Inventors: Angela J. Stessen, Glencoe, MN (US); Noel G. Rudie, Chaska, MN (US); Alicia Stube, Chaska, MN (US)

(73) Assignee: Michael Foods, Inc., Minnetonka, MN (US)

(21) Appl. No.: 17/176,552

(22) Filed: Feb. 16, 2021

Related U.S. Application Data
(60) Provisional application No. 62/977,222, filed on Feb. 15, 2020.

(51) Int. Cl. A21D 2/26; A21D 2/18; A21D 13/047; A21D 13/045; A21D 8/02; A23P 30/25; A23L 15/00

(52) U.S. Cl. CPC A21D 2/262; A21D 2/266; A21D 2/186; A21D 13/047; A23V 2002/00; A21D 8/02; A23P 30/25; A23L 15/20; A21D 13/045

(57) ABSTRACT

A crisp proteinaceous food product provided from ingredients in which egg white proteins constitute the majority of total proteins present is described. Other ingredients include water, expanded starch(es), vegetable flour(s), and at least one source of vegetable protein. The protein can be labeled as being more than 50% (w/w) protein, and at least 50% (w/w) of those denatured proteins can be ovalbumin (or trace their origin to ovalbumin).

### CROSS-REFERENCE TO RELATED APPLICATION

This application claims the benefit of U.S. provisional patent appl. No. 62/977,222, filed 15 Feb. 2020, the disclosure of which is incorporated herein by reference.

### BACKGROUND INFORMATION

Protein crisps have been prepared from dairy products and a variety of vegetables including soy, rice, peas, quinoa, sorghum, and the like. These crisped food items then get incorporated into snack bars, cereals, baked goods, etc.

In recent years, soy crisps have gained in popularity due to consumer demand for protein and snack bars and the relatively good bioavailability of soy protein. However, soy protein crisps often need to be masked with a strong flavor (e.g., chocolate and/or peanut butter) due to off flavors resulting from the presence of chemicals such as aldehydes, ketones, furans, n-alkanols, geosmin, and chlorogenic acid.

Avian eggs, particularly hen eggs, have been a food staple for centuries. Over time, different uses have manifested for egg whites and egg yolks. Egg white, also known as albumen, is the clear, alkaline liquid portion of the egg surrounding the egg yolk. It constitutes roughly two-thirds of a chicken egg by weight.

Egg white includes 10-12% (w/w) proteins. Slightly more than half of an egg's protein content, yet very little of its fat content and none of its cholesterol, is contained in the egg white. Advantageously, egg white is free of many of the organic compounds responsible for the aforementioned off flavors which must be masked with sugar or strongly flavored additives or coatings.

Nearly 150 egg white proteins have been identified including, for example, ovalbumin, ovotransferrin, ovomucoid, ovoglobulin G2 and G3, ovomucin, lysozyme, ovoinhibitor, ovoglycoprotein, flavoprotein, and ovomacroglobulin. By far, the most prevalent protein in egg white is ovalbumin.

Advantageously, egg white protein is highly bioavailable, much more so than the protein available from many other sources including, for example, soy.

However, the nature of the proteins in egg white have inhibited the use of these proteins in the production of the type of crisps described previously. If extrusion techniques commonly employed in the manufacture of soy protein crisps are used with egg white protein, the extruder becomes obstructed or, failing that, a texturized protein (rather than a crisp) results; generally employed processing conditions result in undesirable configuration and/or association of egg proteins in the extruder, thereby preventing formation of a crisp.

U.S. Pat. Publ. No. 2009/0220674 A1 describes an expanded food product made from egg whites. The resulting expanded food product is said to have a density of less than 100 g/L, which is far below that required for many end use applications such as, for example, protein and nutrition bars where expanded food products with more firmness and crispiness are employed.

Intl. patent appl. publ. no. WO 2020/092432 describes a crisp proteinaceous food product in which ovalbumin constitutes at least 33% (w/w) of the total proteins present. That product, which has a bulk density of from ˜120 to ˜500 g/L, includes from ˜22.5 to ˜55% (w/w) protein and from ˜25 to ˜77% carbohydrate (w/w) on a moisture free basis.

Crisp food products with even higher protein contents and reduced amounts of starchy carbohydrates, particularly those where a majority of the protein derives from egg white proteins, remain desirable.

### SUMMARY

Hereinafter is described a crisp proteinaceous food product in which egg white proteins constitute the majority of total proteins employed in the manufacture of the food product.

In one aspect is provided a proteinaceous food product having a crispy texture. The food product is made from ingredients which includes water, starch, proteins from both egg and vegetable sources, and vegetable flour(s). Ovalbumin constitutes at least 33% (w/w) of the proteins, which become denatured during processing. In some embodiments, starch can constitute no more than 20% (w/w) of the food product's ingredients. In these and other embodiments, a weight ratio of product resulting from total proteins to product resulting from carbohydrates is of from 1:2 to 2:1.

The proteinaceous product can be consumed as-is or can be used as an ingredient in a processed food item, e.g., a protein or nutrition bar. When used as an ingredient, the processed food item also can include other ingredients such as, for example, oil and/or flavorings.

In another aspect is provided a process for providing the proteinaceous food product having a crispy texture.

Unless a portion of text specifically indicates otherwise, all percentages throughout this document are weight percentages, i.e., w/w.

The more detailed description that follows provides additional details which explain and exemplify the aforedescribed products and processes. The relevant portion(s) of any patent or publication specifically mentioned is or are incorporated herein by reference.

### BRIEF DESCRIPTION OF THE DRAWINGS

FIG. 1 depicts a simplified schematic representation, not to scale, of the screws from a twin screw extruder, with protecting barrel removed, which can be used in the production process described herein.

### DETAILED DESCRIPTION OF ILLUSTRATIVE EMBODIMENTS

The following discussion is presented to enable a person skilled in the art to make and use one or more of the present embodiments. The general principles described herein may be applied to embodiments and applications other than those detailed below without departing from the spirit and scope of the disclosure. Therefore, the present embodiments are not intended to be limited to the particular embodiments shown, but are to be accorded the widest scope consistent with the principles and features disclosed or suggested herein.

The singular forms “a,” “an,” and “the” include plural referents unless the context clearly dictates otherwise.

As summarily described above, described herein are high-protein extruded products and methods of making such extruded products. The extruded products present protein-rich, even high-protein, alternatives to products normally associated with high levels of carbohydrates.

A high-protein product is one which provides at least 20% of the FDA daily value of that nutrient. Because that daily value in the case of protein is 50 g, a high-protein product needs to provide at least 10 g protein per serving. Medium-density (20-43 g/cup) breakfast cereals and many snacks (chips, snack mixes, extruded snacks, etc.) have a serving size of 30 g, meaning that they must be 33% (w/w) protein to be labeled as high-protein.

In the description that follows, a proteinaceous food product having a crispy texture is referred to as a crisp.

Required dry ingredients include dried egg whites, preferably egg white powder, starch, one or more vegetable proteins, and one or more pre-gelatinized vegetable flours.

Egg white powder is a form of dried egg whites, a food product which is regulatorily defined in the United States; see 21 C.F.R. § 160.145. Both dried egg whites generally and egg white powders specifically are commercially available from a variety of sources.

The second required dry ingredient, starch, can be derived from a variety of sources including, but not limited to, corn, rice, potatoes, wheat and tapioca. Alternatively, a food product that includes a large amount of starch, e.g., certain wheat and corn flours, can be used in place of some of the starch, with blends of different starches and/or starchy food products also are contemplated. The type of starch or starch-containing product can impact the organoleptic properties of the resulting extruded food product, and ordinarily skilled food chemists can adjust the choice and amount of various starches or starchy products accordingly.

Contrary to the teaching of WO 2020/092432, the amount of starch employed as an ingredient typically does not exceed 20%, preferably does not exceed 17.5%, more preferably does not exceed 15%, and most preferably does not exceed 12.5% (all w/w) of the total weight of all dry ingredients.

The weight ratio of dried egg white (egg white powder) to starch(es) generally ranges from 3:1 to 7:1 and commonly from 7:2 to 6:1. In some embodiments, the amount of dried egg white (or egg white powder) constitutes from 75 to 85% (w/w), preferably 77.5 to 82.5% (w/w), and more preferably from 79 to 82% (w/w) of the sum of egg-based component(s) and starch(es).

Another required dry ingredient is vegetable protein, such as isolates or concen-trates of soy beans, mung beans, rice, peas and the like. Preferred among these is pea protein due to considerations such as its bland flavor, tendency toward being non-allergenic and ease of availability and processability. Commercially available vegetable proteins generally include from 50 to 95% WO, and commonly from 75 to 90% (w/w), protein. For example, certain pea proteins are labeled as being ˜80% (w/w) protein.

The weight ratio of dried egg white (egg white powder) to vegetable protein ingredient(s) generally ranges from 7:2 to 10:1 and commonly from 4:1 to 6:1. In some embodiments, the amount of dried egg white (or egg white powder) constitutes from 77.5 to 87.5% (w/w), preferably 78 to 86% (w/w), and more preferably from 79 to 84% (w/w), of the sum of egg-based component(s) and vegetable protein(s).

A further required dry ingredient is pre-gelatinized vegetable flour, which is made by cooking a vegetable at high temperature and under pressure (which assists in terms of uniformity of viscosity) before being ground into a flour. (The cooking process results in gelatinization of most of the starches and denaturing of the proteins.)

Exemplary vegetables from which such flours can be made include rice, pea, red lentil (preferably decorticated), chickpea, and navy bean (preferably decorticated), with pre-gelatinized pea flour constituting a preferred option.

The weight ratio of pre-gelled vegetable flour to starch(es) generally ranges from 5:2 to 5:1 and commonly from 7:2 to 9:2. The amount of vegetable flour(s) can constitute, in different embodiments and depending in large part on the identity and properties of the flour(s) employed, from 27 to 36%, from 28 to 35%, or from 30 to 37% (all w/w) of the total weight of all ingredients.

Three representative starch-flour combinations, each based on use of 44% egg white powder, 10% pea protein (80% by weight protein), and 0.75% CaCO₃ (all w/w based on total weight of dry ingredients) are tabulated below.

TABLE 1

| | flour (%) | tapioca starch (%) |
|---|---|---|
| pre-gelatinized rice flour¹ | 34-36 | 9-11.5 |
| pre-gelatinized pea flour² | 32-35 | 10-13 |
| pre-gelatinized decorticated | 32-35 | 10-13 |
| red lentil flour² | | |

(1) Commercially available from, for example, PGP International (Woodland, Calif.) or Rivland (a partnership between Riviana Foods Inc. and Riceland Foods, Inc.)
(2) Commercially available from, for example, Archer Daniels Midland Co. (Chicago, Ill.)

An ordinarily skilled artisan can use these, in view of the preceding discussion, to create dozens of additional combinations.

Additional dry ingredients can be included in the initial mixture and/or be added later in the process. Examples of additional dry ingredients include GRAS food acids, flavorants such as sweeteners (e.g., monk fruit), spices and seasonings, texture modifiers (e.g., CaCO₃), minerals (e.g., CaSO₄, Na₂CO₃ and K₂CO₃), vitamins, mono- and diglycerides, lecithin, inulin, and fiber. The amounts of such additional dry ingredients can vary greatly, although the sum of such ingredients typically is less than 5%, often no more than 2.5%, and commonly no more than 0.5% (w/w).

The dry ingredients typically have a light, fluffy, powdery consistency. They preferably are mixed prior to introduction to the extruder (using, for example, a ribbon blender), typically at or near ambient temperature. No special mixing equipment or techniques are required.

Dry ingredients preferably are introduced to water in a preconditioning step. Dry ingredients are fed at 65 to 120 g/sec (˜9 to ˜16 lb./min.), commonly 75 to 115 g/sec (˜10 to ˜15 lb./min.), and typically 80 to 105 g/sec (˜11 to ˜14 lb./min.), while water is introduced at a rate of from 2 to 6 g/sec (˜15 to ˜50 lb./hr.), commonly from 2.5 to 5.5 g/sec (˜20 to ˜45 lb./hr.), and typically from 3 to 5 g/sec (˜25 to ˜40 lb./hr.). Typically less than 15% (w/w), usually as little as 5% (w/w), of the total water employed is added to the preconditioning vessel. The preconditioning step can occur at ambient temperature, although steam can be added to the preconditioning vessel to begin heating the flours. All flours (and sweeteners, if used) can be blended and added at the same time or, less preferably, can be added sequentially.

The product of the preconditioning step can be fed into the inlet of an extruder, where the remainder of the process (e.g., mixed, heating under pressure, expansion, etc.) can occur. Because many extruders are able to perform each of these steps, little or no pre- or post-processing is required. Various parts that may be associated with the extruder can grind, hydrate, shear, homogenize, mix, compress, and de-gas the ingredients fed to the extruder.

Extrusion can include melting and/or plasticization of certain ingredients, gelatinization of starch and denaturation of proteins, with the necessary heat resulting from any of variety of sources such as steam injection, external heating of the extruder barrel, or inputted mechanical energy. By varying processing conditions and dies, extrusion can yield food products with little expansion (e.g., pasta), moderate expansion (e.g., shaped breakfast cereal, texturized soy (i.e., meat substitute), modified starches, pet food, etc.), or significant expansion (e.g., puffed cereal or snacks); crisps fall into the lattermost category.

When pressurized extrudate exits the extruder barrel and encounters reduced pressure and temperature, it expands and cools, resulting in a puffed product. The puffed product can be of different shapes and sizes, depending on the die through which it passes and the frequency with which it is cut. Subsequent drying can result in a food product moisture content of from ˜1% to ˜8%, preferably no more than 5%, and more preferably no more than 3%.

Once the amount of residual water is subtracted from the weight of the resulting crisp product, the aforedescribed ingredient ratios and percentages apply to the final crisp product as well.

The ratio of primary dry ingredients, the amount of water added in the extruder, and the amount of energy (both thermal and mechanical) inputted into the mixture while it is in the extruder all impact the ability to obtain a proteinaceous food crisp product with the desired bulk density. The aforedescribed process has wider tolerances than the one taught in WO 20/092432 due to the presence of the pre-gelatinized flours.

The paragraphs which follow describe one set of conditions which can be used with a twin-screw extruder to provide protein crisps having a desired combination of properties. These exemplary conditions can be adjusted to account for available equipment and specific desired final product characteristics. For additional information on the production of protein crisps generally, the interested reader is directed to any of a variety of publications including K. E. Allen et al., “Influence of protein level and starch type on an extrusion-expanded whey product,” Intl. J. Food Sci. and Technol., 42, 8, pp. 953-60 (2007), H. F. Conway et al., “Protein-Fortified Extruded Food Products,” Cereal Science Today, 18, 4, pp. 94-97 (1973), and L. Yu et al., “Protein rich extruded products prepared from soy protein isolate-corn flour blends,” LWT Food Sci. Technol., 50:1, pp. 279-89 (2013); texts such as C. Mercier et al., Extrusion Cooking (Am. Assn. of Cereal Chemists, 1989) and L. Moscicki (ed.), Extrusion-Cooking Techniques (Wiley-VCH, 2011); and patent documents such as U.S. Pat. Publ. Nos. 2007/0077345, 2008/0102168, 2015/0296836 and the like.

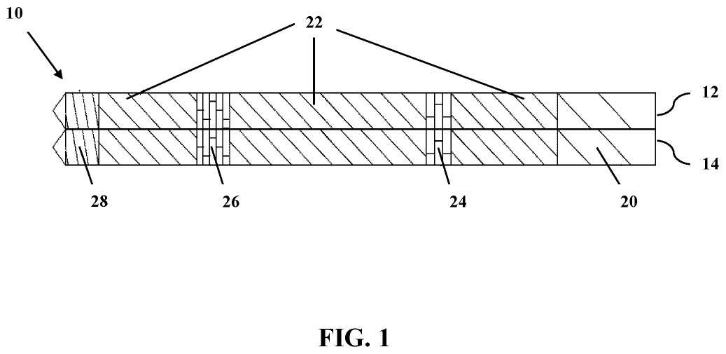

A simplified schematic representation of the screws from an exemplary extruder which can be used is shown in FIG. 1, with ingredient movement being from right-to-left.

Extruder 10 includes screws 12 and 14. (Simplified depictions of flights have been included on the screws, although an ordinarily skilled artisan understands how the zones described below employ flights of differing shapes, depths, frequency and the like.)

In the particular embodiments depicted in FIG. 1, each of screws 12 and 14 includes the same sections, which is common. The reference numerals are shown in connection with only one or the other of screws 12 and 14, although the ordinarily skilled artisan understands that the sections represented apply to both of screws 12 and 14.

Initial conveying section 20 acts to clear powdery ingredients from the inlet, thereby preventing backups or blockages. To accomplish this type of conveyance at a sufficient rate, a long pitch configuration is preferred.

Water, as well as other optional liquids such as dyes, oils, and the like can be added in initial conveying section 20, very shortly after introduction of the dry ingredients. Pressurization of these liquids (or at least the water) permits introduction through a nozzle at an essentially constant addition rate. The liquid(s) need not be heated or chilled prior to introduction, although these possibilities are not excluded.

After initial conveying section 20, the depicted design includes forward conveying sections 22 separated by first kneading section 24 and second kneading section 26. Three or more kneading sections can be desirable in some embodiments.

The combination of conveying and kneading sections preferably make up 65-85% of the lengths of screws 12 and 14. The ratio of conveying-to-kneading zone lengths typically is at least 2:1.

When cut screws, which permit backward slipping of solids, are used, crisps with unacceptable amounts of undesirable texturizing can sometimes result. However, because the use of cut screws tends to reduce surging and to keep pressure on the die more stable, their use can be desirable in some instances.

The mixture is conveyed into and along the barrel, during which time it receives relatively low amounts of inputted mechanical energy, throughout the initial portions of screws 12, i.e., the conveying sections.

Distal section 28 of screws 12 and 14 pushes dough through, typically, cone screws. Both compression and final conveying occur here.

In the present method, heating of zones of the extruder is preferred, preferably in a manner such that the temperatures of the zones increase from input to output ends. An exemplary temperature profile starts at 30° to 35° C. in an initial zone, increases to 70° to 75° C. in the next, and then rises to 90° to 115° C. through one or more additional zones. The ordinarily skilled artisan is aware that one or more of these three zones can be further subdivided into smaller zones and/or that additional zones can be included, e.g., between the second and third zones. (Even if thermal energy from an external source is not inputted, the extruded contents typically experience a temperature rise due to conversion of mechanical work.)

The ratio of screw length to inner diameter of the extruder barrel is at least 14:1, preferably at least 16:1, and most preferably at least 18:1, although typically not exceeding 25:1.

The extruder screw speed can range from 200 to 600 rpm, preferably from 250 to 500 rpm, and more preferably from 300 to 400 rpm, with the specific speed depending largely on type and design of extruder and desired throughput. (Both the minimum and maximum speeds in the preceding sentence have a tolerance of ±10%.)

Water can be introduced to the interior of the extruder at a rate of from 8.5 to 13.5 g/sec (˜65 to ˜105 lb./hr.), preferably from 10 to 12.5 g/sec (˜80 to ˜100 lb./hr.), more preferably from 11 to 12 g/sec (˜85 to ˜95 lb./hr.). Introduction typically occurs at the end of the initial zone and/or the beginning of the next zone and continues throughout much of the remainder of the extruder barrel.

The ratio of liquid-to-dry inputs impacts operating pressures, with higher ratios resulting in lower pressures and lower ratios resulting in higher pressures. An exemplary target extruder operating pressure range in the extruder is 10 to 12.5 MPa (˜1500 to ˜1800 psi), assuming that the equipment is rated for such pressures. This range applies to a wide range of extruders, including models manufactured by Wenger (Sabetha, Kans.) and Baker Perkins Ltd. (Peterborough, UK).

Temperature of material exiting the die preferably is at least ˜100° C., more preferably at least ˜105° C., and even more preferably at least ˜110° C., but preferably no more than ˜165° C., commonly no more than ˜160° C., and typically no more than ˜155° C. (Any of the foregoing minimums can be combined with any of the maximums to provide preferred ranges.) For example the temperature of the material existing the die can be in the range from ˜100° C. to ˜165° C., from ˜105° C. to ˜160° C., or from ˜110° C. to ˜155° C.

Die sizes and shapes can vary according to the desired end shape and size of the protein crisp product and the feed rate of the extruder, e.g., the extruder needs to be able to keep the die “flooded” to reduce the possibility of surging. In practice, a larger diameter (e.g., 4 mm) die appears to correlate to slightly better texture and expansion, perhaps due to less constriction/shear of the material. Dies ranging from 0.5 mm slits to a 4.0 mm circles have produced acceptable products.

If no cutting device is used, extrudate emerges in the form of a rope.

Use of a cutting device with cutter segments cuts the rope into the pieces and creates spheres, oblong cylinders, and the like. End-use application drives the form of the cutting device and its frequency.

Extrudate typically has a moisture content on the order of 10 to 25% (w/w), which is higher than desirable. Heating so as to remove moisture (drying) can reduce the moisture content to less than 5% (w/w) moisture, preferably no more than 4% (w/w), more preferably no more than 3% (w/w). If an oven is used for this drying step, its temperature can be maintained at 82°-93° C. (˜190°±10° F.), which promotes dehydration rather than cooking.

The aforedescribed extrusion process results in denaturing of the proteins included in the ingredients.

Resulting protein crisps typically include, on a moisture free basis, from 33 to 52%, preferably 38 to 51%, more preferably 43 to 50%, and most preferably 45 to 50% of their weight from proteins and from 20 to 50%, preferably 25 to 45%, more preferably 28 to 40%, and most preferably 30 to 35% of their weight from carbohydrate(s). (Ash always accounts for at least a small amount of mass in the final product, so pairing the respective ranges above for protein and carbohydrates typically do not result in a sum of 100%; nevertheless, any of the first set of ranges can be combined with any of the second set to provide combined percentage ranges, with the proviso that the sum of the two percentages cannot exceed 100%.) The weight ratio of product resulting from total proteins to product resulting from carbohydrate(s) commonly ranges from 1:2 to 2:1, typically from 2:3 to 3:2.

Further, at least 30%, preferably at least 33%, more preferably at least 35%, even more preferably at least 39%, and most preferably at least 43% (all w/w) of the (dry) weight of the crisp is ovalbumin (or traces origin to ovalbumin).

Additionally, at least 35%, preferably at least 40%, more preferably at least 45%, and most preferably at least 50% (all w/w) of the (dry) weight of the crisp is protein (or traces origin to a protein). Advantageously, the aforedescribed process can yield a protein crisp which can be labeled as being more than 50% (w/w) protein, a substantial portion of which is egg protein. At least 50%, preferably at least 65%, more preferably at least 70%, even more preferably at least 75%, and most preferably 80 to 85% (all w/w) of the proteins in the crisp can be ovalbumin (or traces origin to ovalbumin).

The aforedescribed process results in a proteinaceous food product having a bulk density of from ˜100 to ˜400, commonly from 110 to 375, and typically from 120 to 360, g/L.

Some end-use applications call for protein crisps with a particular bulk density, or at least a bulk density within a relatively narrow range. For example, many dry breakfast cereals have bulk densities in the range of 120 to 275 g/L, with some specialty cereals (e.g., muesli) being even higher, e.g., 350 to 400 g/L. Crunchy snacks often have bulk densities in the range of 130 to 190 g/L, while breadcrumbs are much higher (e.g., ˜450 g/L). An extruded product intended for one such applications should have a corresponding bulk density value.

Advantageously, the aforedescribed process can provide protein crisps having bulk densities of at least 100, preferably at least 150, and most preferably at least 200 g/L. (Also contemplated are ranges that employ one of the foregoing minimums with another minimum that is higher than the first.) This range permits the resulting protein crisps to be tailored to match (or substitute for) a wide variety of currently employed food products.

Prior to use or packaging, dried crisps preferably are cooled to close to ambient temperature.

The foregoing has been presented by way of example only, the claimed invention is not intended to be limited thereto. The appended claims define the inventions in which exclusive rights are claimed, and they are not intended to be limited to particular embodiments shown and described, from which ordinarily skilled artisans can envision variations and additional aspects; the present disclosure is to be construed as including all such modifications and alterations.

Certain features of the described compositions and methods may have been described in connection with only one or a few such compositions or methods, but they should be considered as being useful in other such compositions or methods unless their structure or use is incapable of adaptation for such additional use. Also contemplated are combinations of features described in isolation.

That which is claimed is:

1. A crisp proteinaceous food product, said food product having a bulk density of from 100 to 400 g/L and being provided from ingredients comprising water, at least one starch, at least one source of egg protein, at least one source of vegetable protein, and at least one pre-gelatinized vegetable flour, wherein at least 33 weight percent of said proteins are ovalbumin and wherein a weight ratio of product resulting from total proteins to product resulting from carbohydrates is of from 1:2 to 2:1.

2. The food product of claim 1 wherein said at least one source of egg protein comprises egg white powder.

3. The food product of claim 2 wherein the majority of said source of egg protein is egg white powder.

4. The food product of claim 2 wherein the weight ratio of egg white powder-to-starch in said ingredients is from 3:1 to 7:1.

5. The food product of claim 4 wherein the amount of egg white powder in said ingredients is from 75 to 85 weight percent of the combined weight of said at least one starch and said at least one source of egg protein.

6. The food product of claim 1 wherein starch constitutes no more than 20 weight percent of said ingredients.

7. The food product of claim 1 wherein said at least one pre-gelatinized vegetable flour is one or more of rice flour, pea flour, and red lentil flour, said red lentil flour optionally being decorticated.

8. The food product of claim 2 wherein the weight ratio of egg white powder-to-vegetable protein in said ingredients is from 7:2 to 10:1.

9. The food product of claim 8 wherein egg white powder is from 77.5 to 87.5 weight percent of the combined weight in said ingredients of said at least one source of egg protein and said at least one source of vegetable protein.

10. The food product of claim 1 wherein said at least one pre-gelatinized vegetable flour constitutes from at least 27 to no more than 37 weight percent of the combined weight of all ingredients.

11. A process for preparing a crisp proteinaceous food product in an extruder having a screw length-to-inner barrel diameter of at least 14:1, and having a temperature profile wherein each segment of said barrel increases from a starting segment temperature of from about 30° to 35° C. to a final segment temperature of from about 90° to 115° C., said process comprising:
a) providing an extrudable blend by introducing into said extruder at a rate of from 8.5 to 13.5 g/sec (1) water and (2) pre-wetted solid ingredients that comprise at least one starch, at least one source of egg protein, at least one source of vegetable protein, at least one pre-gelatinized vegetable flour, and optionally at least one additive;
b) while maintaining a screw rotational speed of from 200 to 600 rpm, conveying said extrudable blend along the length of said extruder barrel;
c) permitting said extrudable blend to exit a die at the distal end of said extruder barrel, thereby providing an extrudate which has a temperature of from 100° to 165° C. and a moisture content of from 10 to 25 weight percent; and
d) reducing the moisture content of said extrudate to less than 5 weight percent, thereby providing a crisp proteinaceous food product having a bulk density of from 100 to 400 g/L.

12. The process of claim 11 wherein at least 33 weight percent of the total proteins in said ingredients is ovalbumin.

13. The process of claim 12 wherein a ratio of total proteins to carbohydrates in said solid ingredients is of from 1:2 to 2:1.

14. The process of claim 11 wherein said at least one source of egg protein comprises egg white powder.

15. The process of claim 14 wherein the weight ratio of egg white powder-to-starch in said solid ingredients is from 3:1 to 7:1.

16. The process of claim 16 wherein the amount of egg white powder in said solid ingredients is from 75 to 85 weight percent of the combined weight of said at least one starch and said at least one source of egg protein.

17. The process of claim 14 wherein the weight ratio of egg white powder-to-vegetable protein in said solid ingredients is from 7:2 to 10:1.

18. The process of claim 17 wherein the amount of egg white powder is from 79 to 84 weight percent of the combined weight of said at least one source of egg protein and said at least one source of vegetable protein.

19. The process of claim 11 wherein starch constitutes no more than 20 weight percent of said solid ingredients.

20. The process of claim 11 wherein said at least one pre-gelatinized vegetable flour constitutes from at least 27 to no more than 37 weight percent of the combined weight of all ingredients.
